(19) United States
(12) Patent Application Publication
(10) Pub. No.: US 2011/0304106 A1
(43) Pub. Date: Dec. 15, 2011

(54) PRESS IN PLACE SEAL

(75) Inventor: Christopher J. Stickling, Dunlap, IL (US)

(73) Assignee: Caterpillar Inc., Peoria, IL (US)

(21) Appl. No.: 12/963,016

(22) Filed: Dec. 8, 2010

Related U.S. Application Data
(60) Provisional application No. 61/287,771, filed on Dec. 18, 2009.

(51) Int. Cl. F16J 15/02

(52) U.S. Cl. 277/649

(57) ABSTRACT

A press-in-place or “PIP” seal has a length and a cross section. The cross section, when in an uncompressed state, includes a top portion that includes a first bead and a second bead. The top portion has a seal width. The cross section further includes a bottom portion having a third bead and a fourth bead. The bottom portion has a narrow width that is narrower than the seal width. A first side surface connects the third bead with the first bead and a second side surface connecting the fourth bead with the second bead.

### TECHNICAL FIELD

This invention relates generally to a press in place of “PIP” seal for sealing an interface between two surfaces.

### BACKGROUND

Seals are used in numerous applications to prevent a fluid from leaking between two structures. Many seals include spaced flexible projections that retain the seal in a channel of a structure during assembly. However, at higher pressures, such as 27.6 MPa or greater, such spaced flexible projections may affect the contact pressure between the seal and the channel causing leakage to occur. For example, in U.S. Pat. No. 5,002,290 a seal is provided to provide fluid tightness but includes such spaced flexible projections.

Also, such intermittent projections may act as a stress raiser causing the seal to fail.

These seals may also fail because of movement in response to an applied pressure. Such movement may cause the seal to roll or twist, allowing fluid to move around the seal and leak.

Additionally, known seals may begin to fail by extruding through the interface between the two structures when in use at higher pressures because the highest strain experienced by the seal during use is found at the surface of the seal proximate the interface of the two structures.

Other examples of seals that may include one or more of the above problems include U.S. Pat. No. 7,314,590, U.S. Pat. No. 6,981,704, U.S. Pat. No. 6,722,660, U.S. Pat. No. 6,264,206, U.S. Pat. No. 5,551,705, U.S. Pat. No. 2,688,506, U.S. Pat. No. 2,954,264, U.S. Pat. No. 2,983,533, JP1998311430, JP3310547, DE1259155, and DE3327624. The present invention is directed to overcome one or more of the problems as set forth above.

### SUMMARY OF THE INVENTION

In one aspect, a PIP seal has a length and a cross section. The cross section, when in an uncompressed state, includes a top portion that includes a first bead having a first center of mass and a second bead having a second center of mass. The top portion has a top width measured from the first center of mass to the second center of mass and includes a first concavity disposed between the first bead and the second bead. The cross section further includes a bottom portion having a third bead having a third center of mass with the third bead being horizontally disposed between the first center of mass and the second center of mass at a first horizontal distance greater than ten percent of the top width from the first center of mass and the second center of mass. The cross section also includes a side surface connecting the third bead with the first bead.

In another aspect, a PIP seal has a length and a cross section. The cross section in an uncompressed state has a seal height and a central vertical axis. The cross section includes a top portion including a first bead and a second bead with the first bead rounds into a first vertical flat and the second bead rounds into a second vertical flat. A seal width extends between the first vertical flat and the second vertical flat. A bottom portion has a third bead and a fourth bead and a first side surface connects the third bead with the first vertical flat. The first side surface extends at an angle to the central vertical axis in a range of about twenty-five degrees to about seventy-five degrees. A second side surface connects the fourth bead with the second vertical flat with the second side surface extends at a second angle to the central vertical axis in a range of about twenty-five degrees to about seventy-five degrees. When the PIP seal is disposed within a channel having a substantially rectangular cross section and covered by a flat surface and the PIP seal is in a compressed state, the PIP seal is subjected to a pressure about 27.6 MPa and a highest strain experienced by the PIP seal is located within the seal. The channel has a channel width equal to the seal width and a channel height being seventy five percent of the seal height.

In another aspect, an assembly includes a first structure including a channel having a substantially rectangular cross section and a channel height and a channel width. The assembly includes a second structure disposed to cover the channel and a PIP seal disposed within the channel in a compressed state. The PIP seal has a cross section such that the cross section of the PIP seal in the compressed state has a trapezoidal shaped strain field.

In another aspect that may be combined with any of these aspects, a bottom portion of the PIP seal may further include a fourth bead having a fourth center of mass horizontally disposed between the first center of mass and the second center of mass at a second horizontal distance greater than five percent of the top width from the first center of mass and the second center of mass.

In another aspect that may be combined with any of these aspects, a bottom portion includes a flat disposed between the third bead and the fourth bead.

In another aspect that may be combined with any of these aspects, a bottom portion has a bottom width being measured from the third center of mass to the fourth center of mass, wherein the top width is 1.2 to 3 times wider than the bottom width.

In another aspect that may be combined with any of these aspects, the first bead, the second bead, the third bead, and the fourth bead have about the same radius.

In another aspect that may be combined with any of these aspects, the PIP seal has a seal height wherein when the PIP seal is disposed within a channel having a substantially rectangular cross section and covered by a flat surface and the PIP seal is in a compressed state, the PIP seal is subjected to a pressure about 27.6 MPa and a highest strain experienced by the PIP seal is located within the PIP seal, wherein the channel has a channel width equal to the seal width and a channel height being seventy five percent of the seal height.

In another aspect that may be combined with any of these aspects, the PIP seal occupies a volume of the channel covered by the flat surface in a range of eighty to ninety percent of the volume.

In another aspect that may be combined with any of these aspects, such that when the PIP seal is in the compressed state in the channel covered by the flat surface, a first strain field extends through the PIP seal at an angle to the side surface in the uncompressed state ranging between 20 degrees and 160 degrees.

In another aspect that may be combined with any of these aspects, the cross section is generally uniform along the length of the seal.

In another aspect that may be combined with any of these aspects, the side surface extends at an angle ranging between 20 degrees and 80 degrees to horizontal.

In another aspect that may be combined with any of these aspects, wherein the top portion includes a first concavity disposed between the first bead and the second bead, wherein the bottom portion includes a flat disposed between the third bead and the fourth bead.

In another aspect that may be combined with any of these aspects, wherein the second concavity, the third bead, and the fourth bead each have a radius, wherein the bottom portion has a narrow width being a sum of a length of the flat plus two times the radii of the third bead plus two times the radii of the fourth bead, wherein the seal width is 1.2 to 3 times wider than the bottom width.

In another aspect that may be combined with any of these aspects, the first bead, the second bead, the third bead, and the fourth bead have the same radius.

In another aspect that may be combined with any of these aspects, such that when the PIP seal is in the compressed state in the channel covered by the flat surface, a first strain field extends through the PIP seal at a third angle to the central axis in the uncompressed state ranging between 10 degrees and 80 degrees.

In another aspect that may be combined with any of these aspects, such that when the PIP seal is subjected to a fluid pressure of about 27.6 MPa on a side of the channel between the first structure and the second structure, a highest strain experienced by the PIP seal is located within the seal.

In another aspect that may be combined with any of these aspects, the PIP seal occupies about eighty to about ninety percent of a volume of the channel and is compressed horizontally and vertically by the channel and the second structure, wherein when the PIP seal is in an uncompressed state. The cross section is generally uniform over an entire length of the PIP seal and includes a top portion including a first bead having a first center of mass and a second bead having a second center of mass. The top portion has a top width measured from the first center of mass to the second center of mass and includes a first concavity disposed between the first bead and the second bead. A bottom portion has a third bead having a third center of mass with the third bead horizontally disposed between the first center of mass and the second center of mass at a first horizontal distance greater than five percent of the top width from the first center of mass and the second center of mass. The bottom portion further includes a fourth bead having a fourth center of mass horizontally disposed between the first center of mass and the second center of mass at a second horizontal distance greater than five percent of the top width from the first center of mass and the second center of mass. The bottom portion includes a second concavity disposed between the third bead and the fourth bead and a bottom width being measured from the third center of mass to the fourth center of mass. The top width is 1.2 to 3 times wider than the bottom width. A first side surface connects the third bead with the first bead and a second side surface connects the fourth bead with the second bead.

### BRIEF DESCRIPTION OF THE DRAWINGS

FIG. 1 is an exploded perspective view of a first structure, a second structure, and a PIP seal of a machine.

FIG. 2 is a cross section taken along line 2-2 of FIG. 1 showing a cross section of the PIP seal.

FIG. 3 is an alternative cross section of the PIP seal.

FIG. 4 is a cross section taken along line 4-4 of FIG. 1 illustrating a channel of the first structure and covered by the second structure.

FIG. 5 shows the cross sections of an O-ring type seal, an H-type seal, and the PIP seal shown in FIG. 2.

FIG. 6 shows the compressed states without pressure applied of the seals of FIG. 5 installed in the channel of the first structure and covered by the second structure, and illustrates the strain distributions and contact pressures of the seals.

FIG. 7 shows the strain distributions and contact pressures of the seals of FIG. 6 with an applied pressure of 27.6 MPa.

### DETAILED DESCRIPTION

As used herein, about means the numerical value plus or minus ten percent.

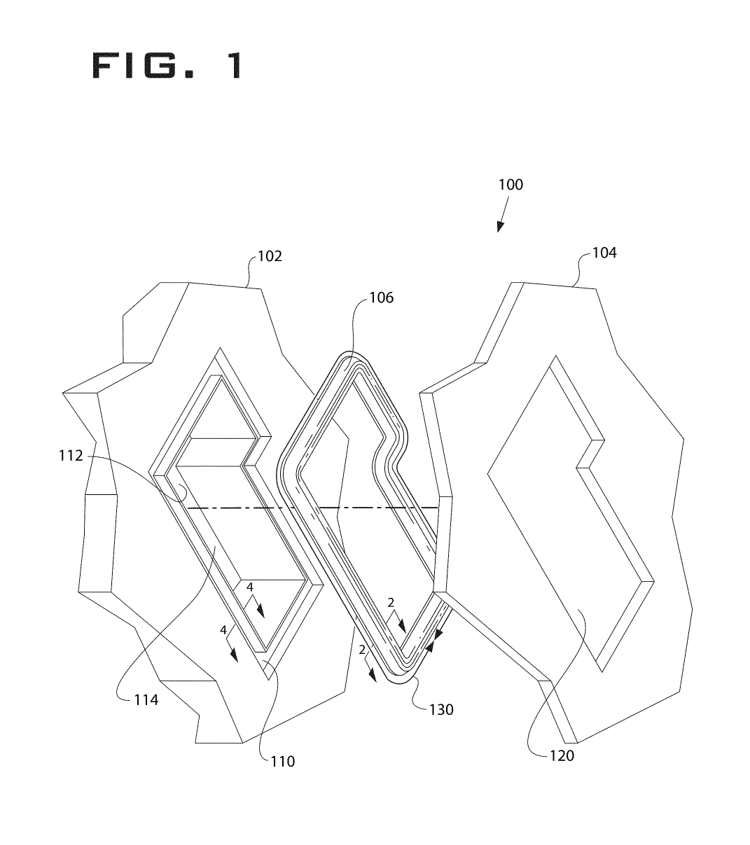

Referring to FIG. 1, an exploded perspective view illustrates an example of an embodiment of the invention. As shown, an assembly 100 includes a first structure 102, a second structure 104, and a PIP seal 106. The first and second structures 102, 104 are the components of a machine that require a fluid seal at an interface between the first and second structures 102, 104. The first structure 102 includes a channel 110 having a substantially rectangular cross section. The channel 110 surrounds an edge 112 of an aperture 114. The second structure 104 includes a mating aperture 120 and covers the channel 110 when assembled.

Fluid may pass through the aperture 114 and the mating aperture 120. The pressure of the fluid may pulse to or remain at high pressures for a period of time. The pressure of the fluid is applied to the PIP seal 106 and the interface between the first and second structures 102, 104.

The PIP seal 106 has a length 130. In some configurations, the PIP seal 106 may have a cross section 132 that is generally uniform along the length 130 of the PIP seal 106. In other words, the PIP seal 106 has a continuous cross section 132 over its length 130 and does not include separate, spaced projections along the length 130, though minor dimensional changes of the cross section 132 may occur due to normal manufacturing variability.

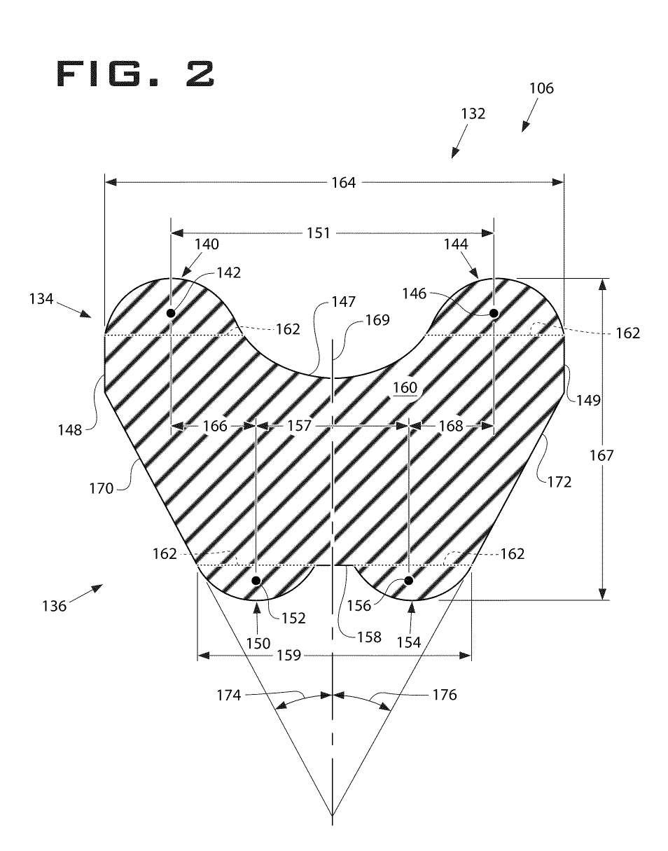

Referring to FIG. 2, a cross section taken along line 2-2 of FIG. 1 illustrates the cross section 132 (shown FIG. 2) of the PIP seal 106 in an uncompressed state. The cross section 132 includes a top portion 134 and a bottom portion 136. The top portion 134 includes a first bead 140 having a first center of mass 142, a second bead 144 having a second center of mass 146, and a first concavity 147 disposed between the first bead 140 and the second bead 144.

Optionally, and as shown, the first bead 140 rounds into a first vertical flat 148 and the second bead 144 rounds into a second vertical flat 149. In this configuration, a seal width 151 extends between the first vertical flat 148 and the second vertical flat 149. A seal width 151 may also be defined as the widest width of the PIP seal 106.

The bottom portion 136 includes a third bead 150 having a third center of mass 152 and a fourth bead 154 having a fourth center of mass 156. A bottom width 157 may be found as the horizontal distance between the third center of mass 152 and the fourth center of mass 156. A flat 158 is disposed between the third bead 150 and the fourth bead 154. The bottom portion 136 has a narrow width 159 being the horizontal distance of the PIP seal 106 along a horizontal line aligned with and passing through the flat 158.

Each bead 140, 144, 150, 154 is a projection from a main body 160 of the PIP seal 106. The boundary between each bead 140, 144, 150, 154 and the main body 160 may be found by placing a horizontal line 162 at the base of each bead 140, 144, 150, 154. The first, second, third, and fourth centers of mass 142, 146, 152, 156 is the center of the area of the cross section of the respective beads 140, 144, 150, 154.

Optionally, the first bead, the second bead, the third bead, and the fourth bead 140, 144, 150, 154 may have the same radius. Of course, the beads 140, 144, 150, 154 may have other shapes, such as trapezoidal, parabolic, or any other projecting shape. Also, a top width 164 of the top portion 134 may be measured from the first center of mass 142 to the second center of mass 146.

The third bead 150 is horizontally disposed between the first center of mass 142 and the second center of mass 146 at a first horizontal distance 166 greater than ten percent of the top width 164 from the first center of mass 142 and the second center of mass 146. The fourth bead 154 having a fourth center of mass 156 horizontally disposed between the first center of mass 142 and the second center of mass 146 at a second horizontal distance 168 greater than ten percent of the top width 164 from the first center of mass 142 and the second center of mass 146. In some configurations, the first horizontal distance 166 may be equal to second horizontal distance 168. Further, the top width may be 1.2 to 3 times wider than the bottom width 157. In other configurations, the top width may be 1.4 to 2 times wider than the bottom width 157.

The PIP seal 106 has a seal height 167. In some configurations, such as the one shown, a central vertical axis 169 may bisect the cross section 132.

A first side surface 170 connects the third bead 150 with the first bead 140 via the first vertical flat 148 and a second side surface 172 connecting the fourth bead 154 with the second bead 144 via the second vertical flat 149. The first side surface 170 and the second side surface 172 may be flat surfaces that extend at a respective first angle 174 and a second angle 176 ranging between fifteen degrees to seventy-five degrees to the central vertical axis 169. Alternatively, the first side surface 170 and the second side surface 172 extend at the respective first and second angles 174, 176 to the central vertical axis 169 in a range of about twenty degrees to about fifty-five degrees or in a range of about twenty-five degrees to about forty degrees.

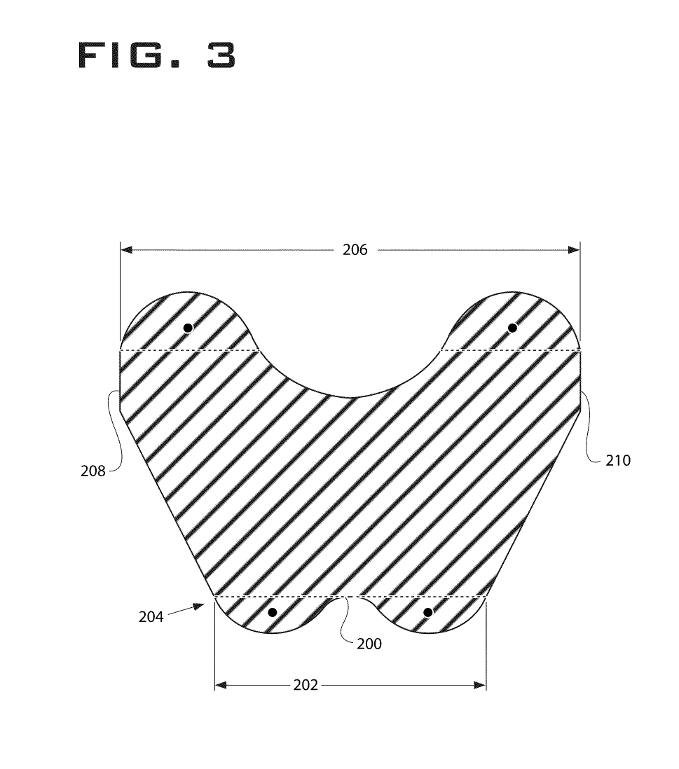

Referring to FIG. 3, a cross section taken along line 2-2 illustrates an alternative embodiment of the PIP seal 106 from FIG. 2. As shown, the flat 158 of FIG. 2 is replaced by a second concavity 200. Consequently, the narrow width 202 of the bottom portion 204 is the length of a horizontal line tangent to the second concavity 200. As shown, a seal width 206 extending from a first vertical flat 208 to the second vertical flat 210 is 1.2 to 3 times wider than the narrow width. Alternatively, the seal width 206 may be 1.5 to 2.5 times wider than the narrow width.

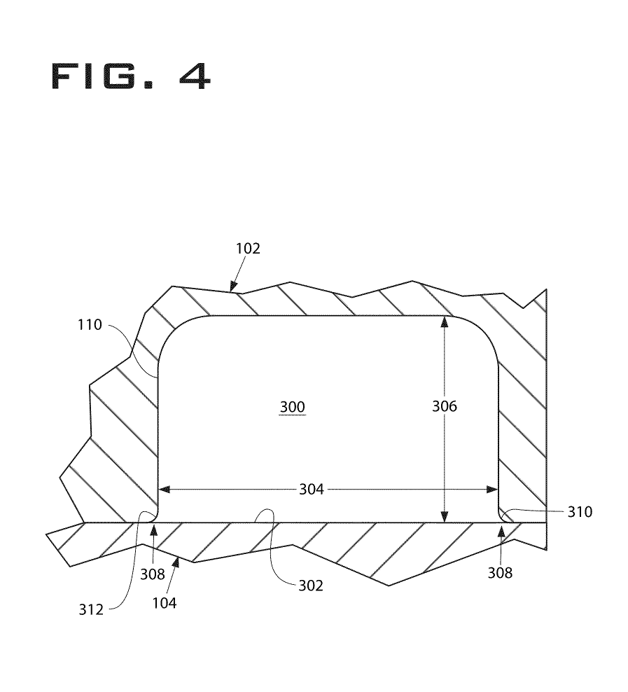

Referring to FIG. 4, a cross section taken along line 4-4 of FIG. 1 illustrates the channel 110 of the first structure 102 covered by the second structure 104. As shown, the channel 110 has a substantially rectangular cross section 300 and covered by a flat surface 302 of the second structure 104. The channel 110 has a channel width 304 that may be about equal to the seal width 151, 206 of FIG. 2 or 3. The channel 110 has a channel height 306 that may be about seventy five percent of the seal height 167. Alternatively, the channel height 306 may range from fifty to ninety-nine percent of the seal height 167.

The PIP seal 106 of FIG. 2 may be used to seal an interface 308 between the first structure 102 and the second structure 104. When the assembly 100 is in use, pressurized fluid may be disposed within the aperture 114 and the mating aperture 120 and thus, apply a pressure at the aperture side 310 of the interface 308, while the remote side 312 of the interface may be at another pressure.

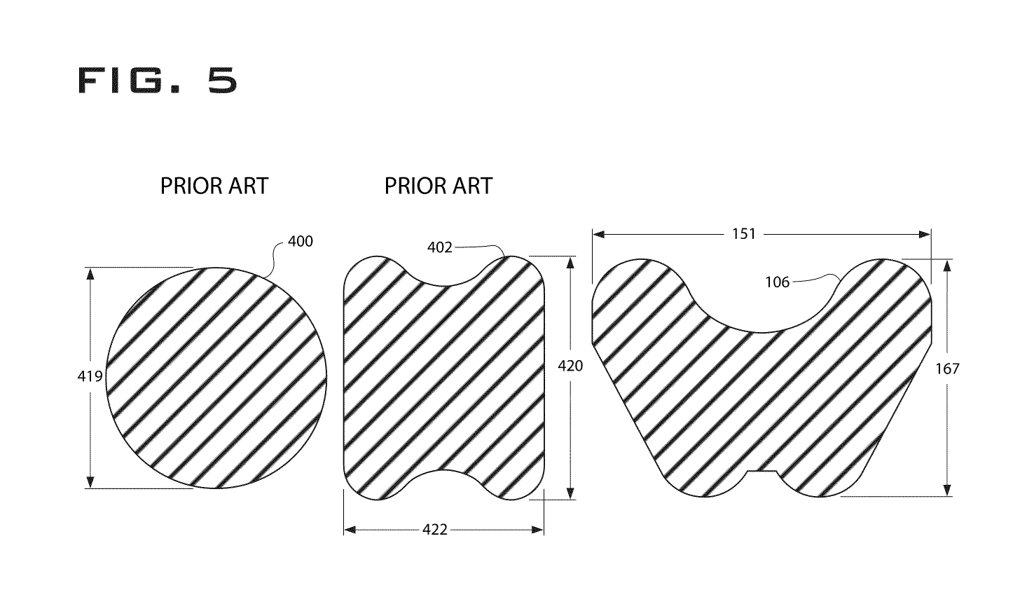

Referring to FIGS. 5, 6, and 7, prior art seals are analyzed in comparison with PIP seal 106 of FIG. 2. Specifically referring to FIG. 5, the cross sections of a prior art O-ring type seal 400 and a prior art H-type seal 402 are shown in an uncompressed state with the PIP seal 106 in an uncompressed state. For this analysis, the O-ring type seal 400 has a diameter 410 of 2.62 mm. The H-type seal 402 has a height 420 of 2.62 mm and a width 422 of 2.19 mm. The PIP seal 106 has a seal height 167 of 2.62 mm and a seal width 151 of 3.54 mm. All of the seals are made of the same material, such as an elastomer, rubber, or other suitable polymer. The channel 110 has a channel width 304 of 3.53 mm and a channel height 306 of 1.95 mm. In other words, the channel width 304 is equal to the seal width 151 and the channel height 306 is seventy five percent of the seal height 167.

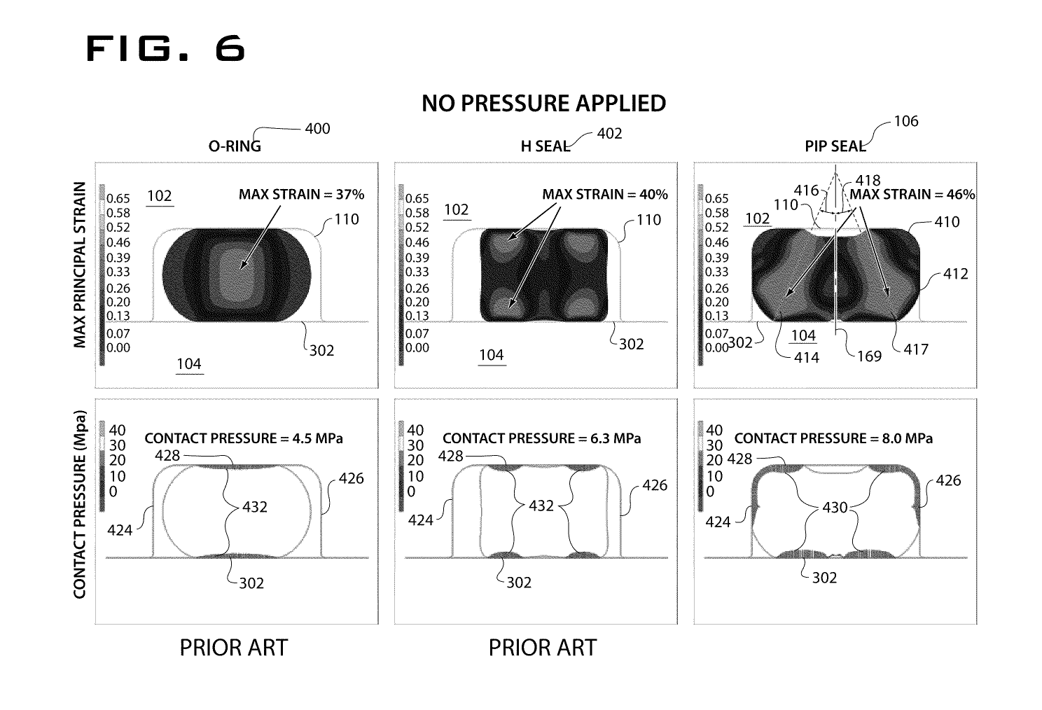

Referring to FIG. 6, the O-ring type seal 400, H-type seal 402, and PIP seal 106 are in a compressed state without pressure applied and installed in the channel 110 of the first structure 102 and covered by the second structure 104.

More specifically, FIG. 6 illustrates the strain distributions and contact pressures of the seals 400, 402, 106. As shown, the PIP seal 106 occupies a volume of the channel 110 covered by the flat surface 302 in a range of eighty to ninety-five percent of the volume. In some configurations, the PIP seal 106 occupies a volume of the channel 110 covered by the flat surface 302 in a range of eighty to ninety percent of the volume. Alternatively, the PIP seal 106 occupies a volume of the channel 110 covered by the flat surface 302 in a range of eighty-three to eighty-five percent of the volume. Further, the PIP seal 106 is compressed horizontally and vertically by the channel 110 and the flat surface 302,

As shown, the cross section 410 of the PIP seal 106 in the compressed state has a trapezoidal shaped strain field 412, which is a somewhat inverse shape to the cross section 132 of PIP seal 106 in the uncompressed state.

A first strain field 414 extends through the PIP seal 106 at a third angle 416 to the central axis 169 ranging between ten degrees and forty-five degrees. In some configurations, the first strain field 414 may extend at the third angle 416 ranging between fifteen degrees and thirty-five degrees or between fifteen degrees and seventy-five degrees. While in others, the first strain field 414 may extend at the third angle 416 ranging between ten degrees and eighty degrees.

A second strain field 417 extends at a fourth angle 418 to the central axis 169 ranging between ten degrees and forty-five degrees. In some configurations, the second strain field 417 may extend at the fourth angle 418 ranging between fifteen degrees and thirty-five degrees or between fifteen degrees and seventy-five degrees. While in others, the second strain field 417 may extend at the fourth angle 418 ranging between ten degrees and eighty degrees.

Additionally, the PIP seal 106 applies a contact pressure 430 against a first side surface 424 and a second side surface 426 to horizontally constrain itself within the channel 110. Consequently, the PIP seal 106 may experience less movement within the groove and be less likely to fail under pulse or cyclic pressure loading applications to maintain a seal between an interface 308 of the first structure 102 and the second structure 104. Thus, scrubbing failure may be prevented by PIP seal 106 because the seal width 151 is about equal to the channel width 304. In some configurations, the seal width 151 may range between five percent larger than the channel width 304 to two percent less than the channel width 304. In others, the seal width 151 may range from one percent larger than the channel width 304 to two percent smaller than the channel width 304. Alternatively, the seal width 151 may range from ten percent larger than the channel width 304 to equal to the channel width 304. Additionally, the PIP seal 106 applies a contact pressure 430 against a bottom surface 428 of the channel 110 and the flat surface 302.

In contrast, the O-ring type seal 400 and the H-type seal 402 only apply a contact pressure 432, 434 against the bottom surface 428 and flat surface 302. Additionally, the PIP seal 106 has a higher contact pressure 436 of 8.0 MPa than the O-ring type seal 400 at 4.5 MPa and the H-type seal 402 at 6.3 MPa.

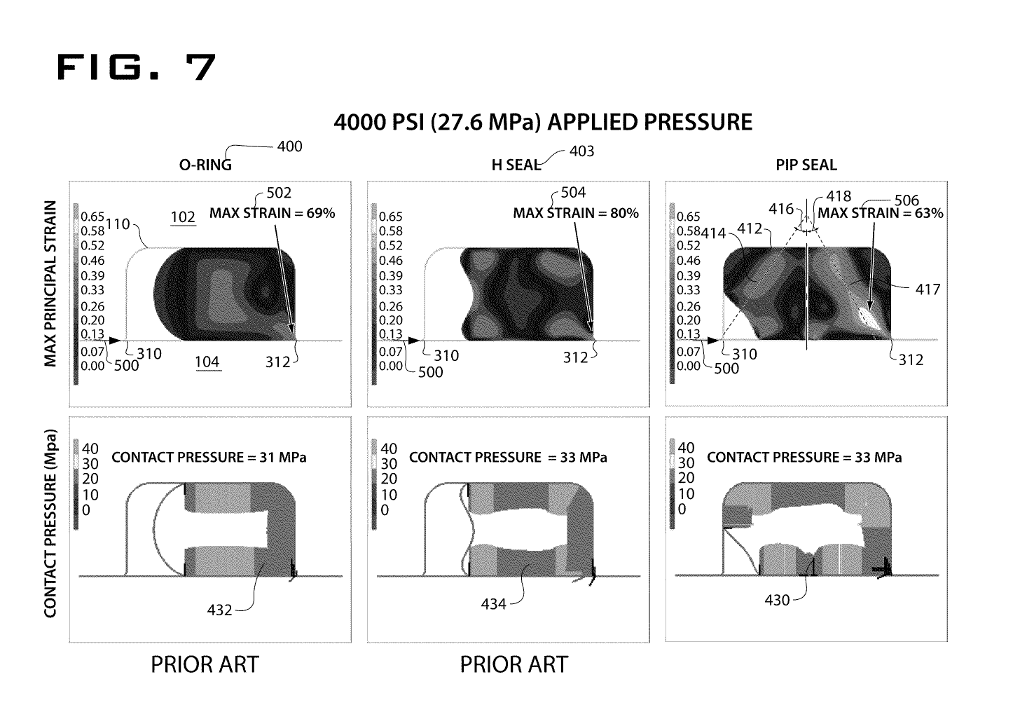

FIG. 7 illustrates the strain distributions and contact pressures of the seals 400, 402, 106 of FIG. 6 with an applied pressure 500 of 27.6 MPa. 19. As shown, the pressure 500 of about 27.6 MPa is applied on an aperture side 310 of the channel 110 between the first structure 102 and the second structure 104.

As shown, the O-ring type seal 400 and the H-type seal 402 have their highest strain 502, 504 located at the remote side 312 of the interface 308 and thus, may begin to suffer extrusion failure at the interface. Unexpectedly, the PIP seal 106 has its highest strain 506 located within the PIP seal 106. Further, the PIP seal 106 has a lower max strain 506 at sixty three percent than either of the O-ring type seal 400 at sixty-nine percent and the H-type seal 402 at eighty percent.

As shown, the cross section 410 of the PIP seal 106 in the compressed state has a trapezoidal shaped strain field 412 and the first strain field 414 extends through the PIP seal 106 at the third angle 416 to the central axis 169 ranging between ten degrees and forty-five degrees. In some configurations, the first strain field 414 may extend at the third angle 416 ranging between fifteen degrees and thirty-five degrees or between fifteen degrees and seventy-five degrees. While in others, the first strain field 414 may extend at the third angle 416 ranging between ten degrees and eighty degrees.

The second strain field 417 extends at the fourth angle 418 to the central axis 169 ranging between ten degrees and forty-five degrees. In some configurations, the second strain field 417 may extend at the fourth angle 418 ranging between fifteen degrees and thirty-five degrees or between fifteen degrees and seventy-five degrees. While in others, the second strain field 417 may extend at the fourth angle 418 ranging between ten degrees and eighty degrees.

As shown, the highest strains 506 within the PIP seal 106 are internally located and remain in the same general location. Thus, the PIP seal 106 is able to transfer the stress of the applied pressure 500 through the body 160 of the PIP seal 106 and use the pressure 500 to increase the sealing force of the PIP seal 106. In other words, the PIP seal 106 focuses the stress to an internal location to prevent extrusion and increase the sealing force against the surfaces 302, 424, 426, 428 to prevent a leak through the remote side 312 of the interface 308.

In contrast, the highest strains 502, 504 of the prior art seals 400, 402 move as the pressure 500 is applied to concentrate at an exterior surface of the seals 400, 402 at the remote side 312 of the interface 308.

Further, the contact pressures are relatively similar with the PIP seal 106 having a contact pressure of 33 MPa, the O-ring type seal 400 at 31 MPa, and the H-type seal 402 at 33 MPa.

### INDUSTRIAL APPLICABILITY

In general, it is believed that the features of the PIP seals disclosed herein provide superior sealing capability, durability, and longevity in high pressure applications. Such applications may include, but is not limited to hydraulic pumps, motors, actuators, and connections.

What is claimed is:

1. A PIP seal comprising:
a length, and
a cross section being generally uniform along the length of the seal, wherein when the cross section is in an uncompressed state, the cross section includes;
a top portion including a first bead having a first center of mass and a second bead having a second center of mass, wherein the top portion has a top width measured from the first center of mass to the second center of mass, the top portion including a first concavity disposed between the first bead and the second bead;
a bottom portion having a third bead having a third center of mass, wherein the third bead is horizontally disposed between the first center of mass and the second center of mass at a first horizontal distance greater than ten percent of the top width, wherein the bottom portion further includes a fourth bead having a fourth center of mass horizontally disposed between the first center of mass and the second center of mass at a second horizontal distance greater than five percent of the top width;
a first side surface connecting the third bead with the first bead; and
a second side surface connecting the fourth bead with the second bead.

2. The PIP seal of claim 1, wherein the bottom portion includes a flat disposed between the third bead and the fourth bead.

3. The PIP seal of claim 1, wherein the bottom portion has a bottom width being measured from the third center of mass to the fourth center of mass, wherein the top width is 1.2 to 3 times wider than the bottom width.

4. The PIP seal of claim 2, wherein the first bead, the second bead, the third bead, and the fourth bead have about the same radius.

5. The PIP seal of claim 1, wherein the PIP seal has a seal height and a seal width, wherein when the PIP seal is disposed within a channel having a substantially rectangular cross section and covered by a flat surface and the PIP seal is in a compressed state and when the PIP seal is subjected to a pressure about 27.6 MPa, a highest strain experienced by the PIP seal is located within the PIP seal, wherein the channel has a channel width equal to the seal width and a channel height being seventy five percent of the seal height.

6. The PIP seal of claim 5, wherein when the PIP seal is in the compressed state within the channel covered by the flat surface, the PIP seal occupies a volume of the channel covered by the flat surface in a range of about eighty to about ninety-five percent of the volume.

7. The PIP seal of claim 5, wherein the PIP seal includes a central vertical axis, wherein when the PIP seal is in the compressed state in the channel covered by the flat surface, a first strain field extends through the PIP seal at an angle to the central vertical axis ranging between fifteen degrees and sixty degrees.

8. The PIP seal of claim 1, wherein the PIP seal includes a central vertical axis, wherein the first and second side surfaces extend at an angle ranging between twenty degrees and seventy degrees to the central vertical axis.

9. A PIP seal having a length and a cross section, the PIP seal comprising:
the cross section in an uncompressed state having a seal height, the cross section including;
a central vertical axis;
a top portion including a first bead and a second bead, wherein the first bead rounds into a first vertical flat and the second bead rounds into a second vertical flat, wherein a seal width extends between the first vertical flat and the second vertical flat;
a bottom portion having a third bead and a fourth bead;
a first side surface connects the third bead with the first vertical flat, wherein the first side surface extends at an angle to the central vertical axis in a range of about twenty-five degrees to about seventy-five degrees; and
a second side surface connects the fourth bead with the second vertical flat, wherein the second side surface extends at a second angle to the central vertical axis in a range of about twenty-five degrees to about sixty-five degrees;
wherein when the PIP seal is disposed within a channel having a substantially rectangular cross section and covered by a flat surface and the PIP seal is in a compressed state, the PIP seal is subjected to a pressure about 27.6 MPa and a highest strain experienced by the PIP seal is located within the PIP seal, wherein the channel has a channel width about equal to or less than the seal width and a channel height being seventy five percent of the seal height.

10. The PIP seal of claim 9, wherein the top portion includes a first concavity disposed between the first bead and the second bead, wherein the bottom portion includes a flat disposed between the third bead and the fourth bead.

11. The PIP seal of claim 10, wherein a narrow width is a distance from the first side surface to the second side surface along a horizontal line passing through a flat disposed between the third bead and the fourth bead, wherein the seal width is 1.2 to 3 times wider than the narrow width.

12. The PIP seal of claim 9, wherein when the PIP seal is disposed within the channel covered by the flat surface, the PIP seal occupies a volume of the channel covered by the flat surface in a range of about eighty to ninety-five percent of the volume.

13. The PIP seal of claim 9, wherein when the PIP seal is in the compressed state in the channel covered by the flat surface, a first strain field extends through the PIP seal at a third angle to the central vertical axis in the uncompressed state ranging between ten degrees and eighty degrees

14. The PIP seal of claim 9, wherein the cross section is generally uniform along the length of the seal.

15. The PIP seal of claim 9, wherein the top portion includes a first concavity disposed between the first bead and the second bead and the bottom portion includes a second concavity disposed between the third bead and the fourth bead.

16. An assembly comprising:
a first structure including a channel having a substantially rectangular cross section and a channel height and a channel width;
a second structure disposed to cover the channel; and
a PIP seal disposed within the channel in a compressed state, the PIP seal having a cross section, wherein when the cross section of the PIP seal in the compressed state, the PIP seal has a trapezoidal shaped strain field.

17. The assembly of claim 16, wherein when the PIP seal is subjected to a fluid pressure of about 27.6 MPa on a side of the channel between the first structure and the second structure, a highest strain experienced by the PIP seal is located within the PIP seal.

18. The assembly of claim 17, wherein the PIP seal occupies about eighty to about ninety percent of a volume of the channel and is compressed horizontally and vertically by the channel and the second structure, wherein when the PIP seal is in an uncompressed state, the cross section is generally uniform over an entire length of the PIP seal and the cross section includes:
a top portion including a first bead having a first center of mass and a second bead having a second center of mass, wherein the top portion has a top width measured from the first center of mass to the second center of mass, the top portion including a first concavity disposed between the first bead and the second bead;
a bottom portion having a third bead having a third center of mass, wherein the third bead is horizontally disposed between the first center of mass and the second center of mass at a first horizontal distance greater than five percent of the top width, wherein the bottom portion further includes a fourth bead having a fourth center of mass horizontally disposed between the first center of mass and the second center of mass at a second horizontal distance greater than five percent of the top width from the first center of mass and the second center of mass, wherein the bottom portion has a bottom width being measured from the third center of mass to the fourth center of mass, wherein the top width is 1.2 to 3 times wider than the bottom width;
a first side surface connecting the third bead with the first bead; and
a second side surface connecting the fourth bead with the second bead.
